(19) United States
(12) Patent Application Publication
(10) Pub. No.: US 2010/0232917 A1
(43) Pub. Date: Sep. 16, 2010

(54) Cement Truck Lift Elevator

(76) Inventor: Dustin Cheyenne Strahler, Marietta, OH (US)

Correspondence Address: KREMBLAS & FOSTER, 7632 SLATE RIDGE BOULEVARD, REYNOLDSBURG, OH, 43068, US

(21) Appl. No.: 12/774,098

(22) Filed: May 5, 2010

Related U.S. Application Data
(63) Continuation-in-part of application No. 11/895,916, filed on Aug. 28, 2007.

(51) Int. Cl. B60P 1/46

(52) U.S. Cl. 414/540; 414/800

(57) ABSTRACT

A cement truck lift elevator for assisting an individual with lifting items up to the mouth of a cement truck's mixing drum to reduce the risk of injury to the individual and any bystanders. The elevator includes an elongated, tubular housing that extends from approximately waist-high upwardly to a point adjacent the mouth of the mixing drum. A lift carriage is located within the housing and is vertically moveable, and axially rotatable at points, relative to the housing. A conveyor platform for holding items is connected to the lift carriage by a mounting arm that extends through a vertically-elongated guide slot in the housing. A lift cable extends from a drive winch, through the frame, to the lift carriage. By operating the drive winch, the lift carriage and the attached conveyor platform are moved vertically along the housing to lift items placed thereon.

### CROSS-REFERENCES TO RELATED APPLICATIONS

This application is a continuation-in-part of U.S. patent application Ser. No. 11/895,916 filed Aug. 28, 2007, which is incorporated herein by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

The present invention relates generally to the field of cement trucks and more particularly to a lift elevator for assisting an operator with lifting heavy items up to the mouth of a cement truck's mixing drum.

2. Description of the Related Art

Traditionally, in order to deposit additives into the mixing drum of a cement truck, it has been necessary for an individual to manually carry a bucket full of additive, commonly weighing over 50 pounds, up a ladder to a height of about 15 feet to dump the additive into the mouth of the mixing drum. It is well known that performing such a task can expose an individual to the risk of serious injury. For example, an individual may experience severe upper body strain or may fall from the ladder while attempting to carry the heavy bucket with one hand and climb the ladder with his or her other hand. Likewise, a bystander may be struck by a bucket that is accidentally dropped by the individual while attempting to perform the task.

In view of the foregoing, it would be advantageous to provide a means for assisting an individual with lifting a container of additive to the mouth of a cement truck's mixing drum that allows the individual to use both of his or her hands to climb the cement truck's ladder. It would further be advantageous to provide such a means that is integral with a cement truck. It would further be advantageous to provide such a means that takes up a minimal amount of space and that is generally unobtrusive when not in use.

### BRIEF SUMMARY OF THE INVENTION

In accordance with the present invention, there is provided a cement truck lift elevator for assisting an operator with lifting heavy items, such as containers filled with cement additives, to the mouth of a cement truck's mixing drum. The preferred lift elevator includes an elongated, tubular lift housing that is rigidly mounted to a cement truck. The lift housing has a guide slot formed in its wall that extends vertically from adjacent the surface upon which the cement truck sits to a point adjacent the mouth of the truck's mixing drum. A drive winch, which is preferably a 12 Volt electric winch, is mounted to the cement truck adjacent the lift housing. The drive winch is operatively connected to a steel lift cable that extends into the lift housing and engages a pair of transmission pulleys that redirect the lift cable downwardly to a cylindrical lift carriage. The lift carriage is axially rotatable and vertically moveable relative to the lift housing. A shelf member is connected to the lift carriage by a mounting arm that extends through the guide slot in the lift housing.

By operating the drive winch, such as with a conventional, wash-down-protected control pad, an operator can spool or unspool the lift cable to raise and lower the shelf member along the length of the lift housing between a “down” position, wherein the shelf member is adjacent the lower end of the lift housing, and an “up” position, wherein the shelf member is adjacent the upper end of the lift housing. As the shelf member is raised and lowered, the mounting arm travels vertically within the guide slot of the lift housing. Limit switches can be installed within the lift housing and operatively connected to the drive winch for causing the shelf member to automatically stop at the “up” and “down” positions.

A lower pivot notch is preferably formed in the lift housing adjacent the “down” position of the shelf member. The lower pivot notch extends perpendicularly from the guide slot for accepting the mounting arm and allowing the shelf member to be pivoted about the axis of the lift carriage between an operating position, wherein the mounting arm is in the guide slot, and a stowed position, wherein the mounting arm is in the lower pivot notch. In the stowed position, the shelf member is nearer the body of the cement truck and is therefore less obtrusive than when the shelf member is in the operating position. The shelf member is preferably securely fastened in the stowed position when the lift elevator is not in use, such as when the cement truck is in transit.

An upper pivot notch that is similar to the lower pivot notch is preferably formed in the lift housing adjacent the “up” position of the shelf member. Like the lower pivot notch, the upper pivot notch allows the shelf member to be rotated about the axis of the lift carriage to a dump position that is nearer the body of the cement truck than the operating position. An operator is thereby not required to move an item, such as a heavy bucket of color additive, very far from the shelf member to dump its contents into the mouth of the cement truck's mixing drum.

Typical use of the lift elevator involves an operator first rotating the shelf member from the stowed position to the operating position and placing an item to be lifted on top of the shelf member. The operator then manipulates the control pad of the drive winch to spool the lift cable, thereby hoisting the shelf member from the down position along the lift housing to the “up” position. Next, the operator climbs to the top of the cement truck's ladder and pivots the shelf member to the dump position, where the shelf member is preferably secured by a removable fastener. The operator then removes the bucket from the shelf member and dumps the contents of the bucket into the mouth of the mixing drum. The operator then replaces the bucket on the shelf member, rotates the shelf member back to the operating position, climbs down the ladder and uses the control pad to lower the shelf member to the “down” position. The shelf member can then be stowed or used again in the manner described above.

### BRIEF DESCRIPTION OF THE SEVERAL VIEWS OF THE DRAWINGS

FIG. 1 is a front view illustrating the preferred embodiment of the present invention.

FIG. 2 is a partial front view illustrating the conveyor platform of the preferred embodiment of the present invention shown in FIG. 1 in the stowed position.

FIG. 3 is a partial front view illustrating the conveyor platform of the preferred embodiment of the present invention shown in FIG. 1 being pivoted to the operational position.

FIG. 4 is a front view illustrating the preferred embodiment of the present invention shown in FIG. 1 with an operator moving the conveyor platform from the “down” position to the “up” position.

FIG. 5 is a front view illustrating the preferred embodiment of the present invention shown in FIG. 1 with an operator climbing to the top of the cement truck's rear ladder.

FIG. 6 is a front view illustrating the preferred embodiment of the present invention shown in FIG. 1 with an operator rotating the conveyor platform from the “operating” position to the “dump” position and removing a bucket from the conveyor platform.

FIG. 7 is a detail view illustrating the lift carriage and the conveyor platform of the preferred embodiment of the present invention shown in FIG. 1.

FIG. 8 is a perspective view illustrating the preferred embodiment of the present invention shown in FIG. 1.

FIG. 9 is a view in section illustrating the preferred embodiment of the present invention shown in FIG. 1.

FIG. 10 is an electrical diagram of the preferred embodiment of the present invention.

FIG. 11 is another electrical diagram of the preferred embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

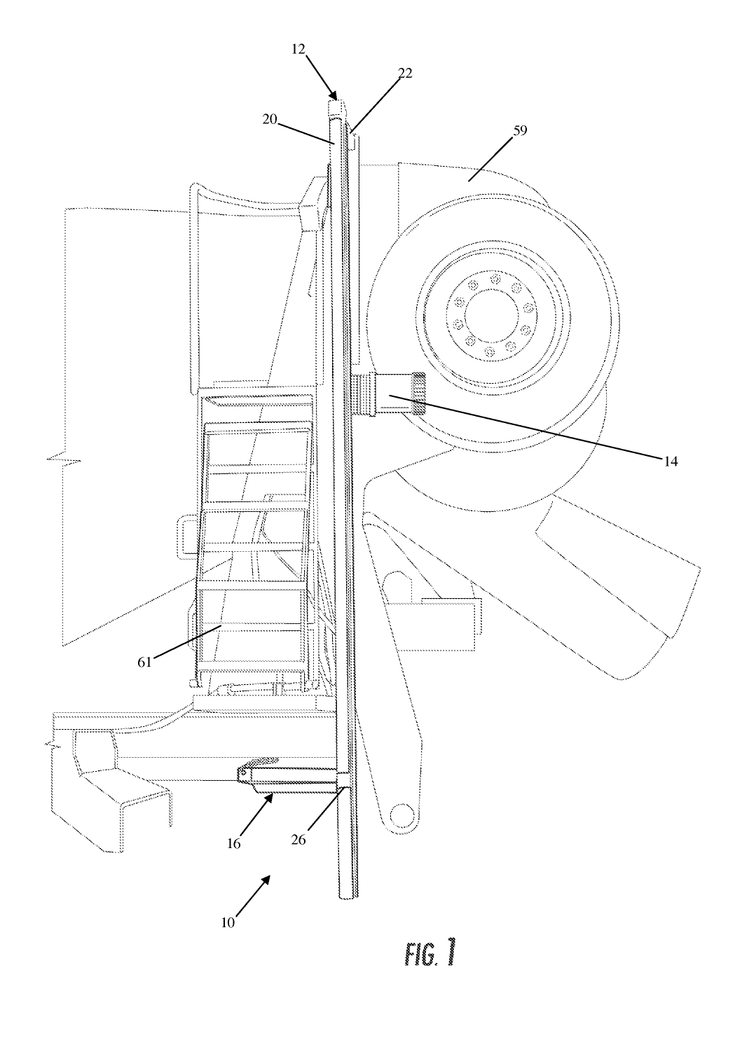

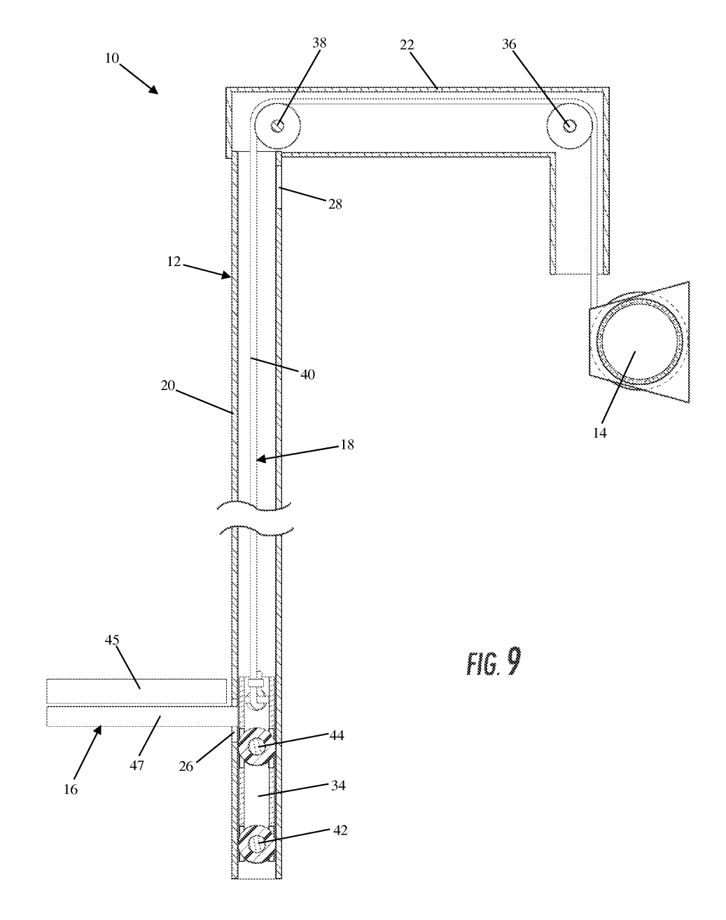

Referring to FIGS. 1, 8 and 9, a cement truck lift elevator (herein referred to as “the elevator”) for assisting an operator with lifting heavy material to the mouth of a cement truck's mixing drum is indicated generally at 10. The elevator 10 includes a lift housing 12, a drive winch 14, a conveyor platform 16 and an internal conveyor assembly 18. For the sake of convenience and clarity, terms such as “top,” “bottom,” “up,” “down,” “inward,” “outward,” “vertical” and “horizontal” will be used herein to describe the relative placement and orientation of the various components of the elevator 10, all with respect to the geometry and orientation of the elevator 10 as it appears in FIG. 8. Said terminology will include the words specifically mentioned, derivatives thereof, and words of similar import.

Referring to FIGS. 8 and 9, the lift housing 12 of the elevator 10 is a generally tubular, inverted J-shaped structure formed of an elongated lift shaft 20 connected at one end to an L-shaped transmission shaft 22. The transmission shaft 22 is preferably formed of a bent segment of 3 inch square steel tubing, and the lift shaft 20 is preferably formed of a straight length of 2¼ inch diameter round steel tubing. It is contemplated that the size and shape of the lift housing 12 may be varied in order to accommodate various cement truck and mixing drum configurations, and the lift housing 12 can be formed of a greater or a fewer number of tubular segments than the two segments that are shown without departing from the present invention. For example, it is contemplated that the lift housing 12 can be formed of a single, continuous length of round tubing that is bent into the inverted J-shaped configuration shown in FIG. 8. Alternatively, it is contemplated that the lift housing 12 can be formed of three interconnected, straight segments of tubing to achieve the illustrated configuration. It is further contemplated that the tubular lift housing 12 can be formed of any other suitably rigid and durable materials, including, but not limited to aluminum, plastic and various composites. Still further, it is contemplated that the tubular lift housing 12 can be replaced by various other open or closed frame-like structures, such as various tubes, rails, beams, shafts or brackets that similarly provide a track, guide or barrier for restricting the movement of the lift carriage 34 to a predefined space as will be described below. The tubular structure is preferred because it provides safety features not found on open-framed structures, but is not essential due to known structures that can otherwise protect users from being hurt with such open-framed structures.

A narrow, elongated guide slot 24 is formed in the wall of the lift shaft 20. The guide slot 24 extends along the entire length of the lift shaft 20 and preferably measures about three-eighths of an inch wide. A first, lower pivot notch 26 is formed in the wall of lift shaft 20 about a foot from the bottom end of the lift shaft 20. The lower pivot notch 26 extends leftward (as shown in FIG. 8) from the guide slot 24 about 130 degrees around the circumference of the lift shaft 20. A second, upper pivot notch 28 is formed in the wall of the lift shaft 20 adjacent the top end of the lift shaft 20. The upper pivot notch 28 is substantially identical to the lower pivot notch 26, except that it extends rightward from the guide slot 24 (as shown in FIG. 8) instead of leftward.

Still referring to FIGS. 8 and 9, the internal conveyor assembly 18 includes a lift carriage 34, two transmission pulleys 36 and 38, and a lift cable 40. The lift carriage 34 is formed of a segment of steel tubing having a length of about 18 inches and a diameter of about 2 inches. It is contemplated that the size of the lift carriage 34 can be varied, although the outer diameter of the lift carriage 34 should be about one-quarter of an inch smaller than the inner diameter of the lift shaft 20. Two guide wheels 42 and 44 are rotatably mounted to the lift carriage 34 adjacent the lift carriage's top and bottom ends. The guide wheels 42 and 44 protrude slightly through cuts-outs 46 and 48 in the wall of the lift carriage 34.

The lift carriage 34 is positioned inside the lift shaft 20 in a substantially coaxial relationship therewith, with the radially outwardly-facing surfaces of the guide wheels 42 and 44 resting against the wall of the lift shaft 20. The lift carriage 34 can thus travel vertically along the interior of the lift shaft 20, with the guide wheels 42 and 44 engaging and riding along the interior of the lift shaft's wall. The guide wheels 42 and 44 do not prohibit significant rotation of the lift carriage 34 relative to the lift shaft 20, but, due to their single axis of rotation, do not promote such rotation. The guide wheels 42 and 44 instead promote smooth, longitudinal movement of the lift carriage 34 within the lift shaft 20, while still permitting rotation of the lift carriage 34 relative to the lift shaft 20 at certain points along the lift shaft's length, as described in greater detail below, provided a sufficient torque is applied to the lift carriage 34.

The transmission pulleys 36 and 38 are conventional fixed pulleys that are rigidly mounted to the interior of the transmission shaft 22 adjacent the ends of the horizontally oriented segment of the transmission shaft 22. The drive winch 14 is a conventional, 12V electric winch, similar to those commonly found on all terrain vehicles (ATVs), although it is contemplated that a similarly sized pneumatic or hydraulic winch can be substituted for the drive winch 14. For example, an industrial hoist can be substituted for the ATV winch. The lift cable 40, which is preferably formed of conventional steel cable, is operatively connected to the drive winch 14 in a conventional manner. The lift cable 40 extends from the drum of the drive winch 14 upwardly, into the transmission shaft 22, and traverses and operatively engages both of the transmission pulleys 36 and 38. The lift cable 40 is thereby redirected downwardly, into the lift shaft 20, and is connected to the lift carriage 34, preferably without contacting the sidewalls of the housing through which it passes. This configuration allows the lift carriage 34 to be raised and lowered through operation of the drive winch 14, as will be described in greater detail below.

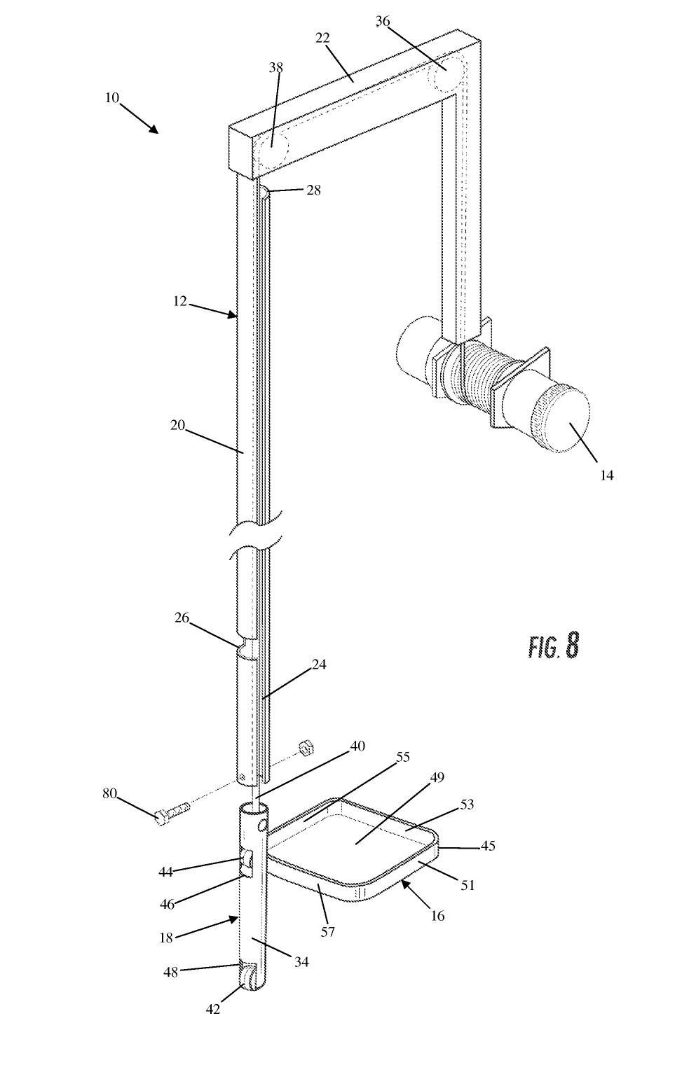

Referring to FIGS. 7-9, the conveyor platform 16 is defined by a shelf member 45 and a mounting arm 47. The shelf member 45 is formed of steel plate and includes a floor 49 that measures 18 inches square. The floor 49 is substantially perpendicular to the axis of the lift carriage 34. Four interconnected sidewalls 51, 53, 55 and 57 are welded to the edges of the floor 49 and extend about 6 inches upwardly therefrom. It is contemplated that the size and shape of the floor 49 and the height of the sidewalls 51-57 can be varied as desired, such as for rendering the shelf member 45 more appropriate for holding smaller or larger items. It is further contemplated that the sidewalls 51-57 of the shelf member 45 can be entirely omitted.

The mounting arm 47 of the conveyor platform 16 is formed of a segment of L-shaped (in section) steel angle measuring about 16 inches in length, although it is contemplated that the mounting arm 47 can alternatively be formed of various other types of elongated brackets, bars, or plates of similar size and strength. Importantly, the mounting arm 47 has a height that is less than the height of the pivot notches 26 and 28 in the lift shaft 20 (described above). The mounting arm 47 extends horizontally from a first end located below the shelf member 45, through the guide slot 24 of the lift shaft 20 (as best shown in FIG. 9), and is welded at a second end to the lift carriage 34 in a transverse relationship therewith. In this configuration, vertical movement of the lift carriage 34 along the lift shaft 20 in response to operation of the drive winch 14 causes the attached conveyor platform 16 to be hoisted and lowered in a like manner. For example, by operating the drive winch 14 to spool the lift cable 40, an operator can cause the lift carriage 34 and the conveyor platform 16 to move upwardly along the lift shaft 20. Conversely, by operating the drive winch 14 to unspool the lift cable 40, an operator can cause the lift carriage 34 and the conveyor platform 16 to move downwardly along the lift shaft 20. In an alternative embodiment, the cable can be formed as a continuous loop that extends from the winch 14 around the pulleys and to the lift carriage 34, and then returns back to the drive winch 14. Thus, the lift carriage can be driven upwardly by rotating the winch 14 in one direction and driven downwardly by rotating the winch 14 in the opposite direction.

The floor 49 of the shelf member 45 is mounted to the mounting arm 47 with conventional removable fasteners for allowing the shelf member 45 to be conveniently removed and replaced as desired. For example, the shelf member 45 can be replaced by a similar shelf member if the original shelf member 45 becomes worn or damaged. Alternatively, the shelf member 45 can be replaced by other types of platforms, shelves, or containers of different sizes and shapes for better accommodating particular items that are to be placed thereon.

Referring to FIG. 1, the lift housing 12 is rigidly mounted to the rear of a cement truck 59, adjacent the truck's rear ladder 61, by a series of brackets and welds (not within view), although it is contemplated that the lift housing 12 can alternatively be mounted to the cement truck 59 with conventional removable fasteners to facilitate convenient removal of the lift housing 12 when desired. The lift shaft 20 is positioned laterally adjacent the rear of the truck 59 in a vertical orientation with the bottom end of the lift shaft 20 suspended about two feet above the surface on which the cement truck 59 sits, and with the top end of the lift shaft 20 positioned adjacent the mouth of the cement truck's mixing drum. The transmission shaft 22 extends horizontally away from the top of the lift shaft 20, toward the central axis of the cement truck 59, and then downwardly to a lower terminus about ten feet above the surface on which the cement truck 59 sits. The drive winch 14 is rigidly mounted to the frame of the cement truck 59, such as by welds or removable fasteners, directly below the lower terminus of the transmission shaft 22.

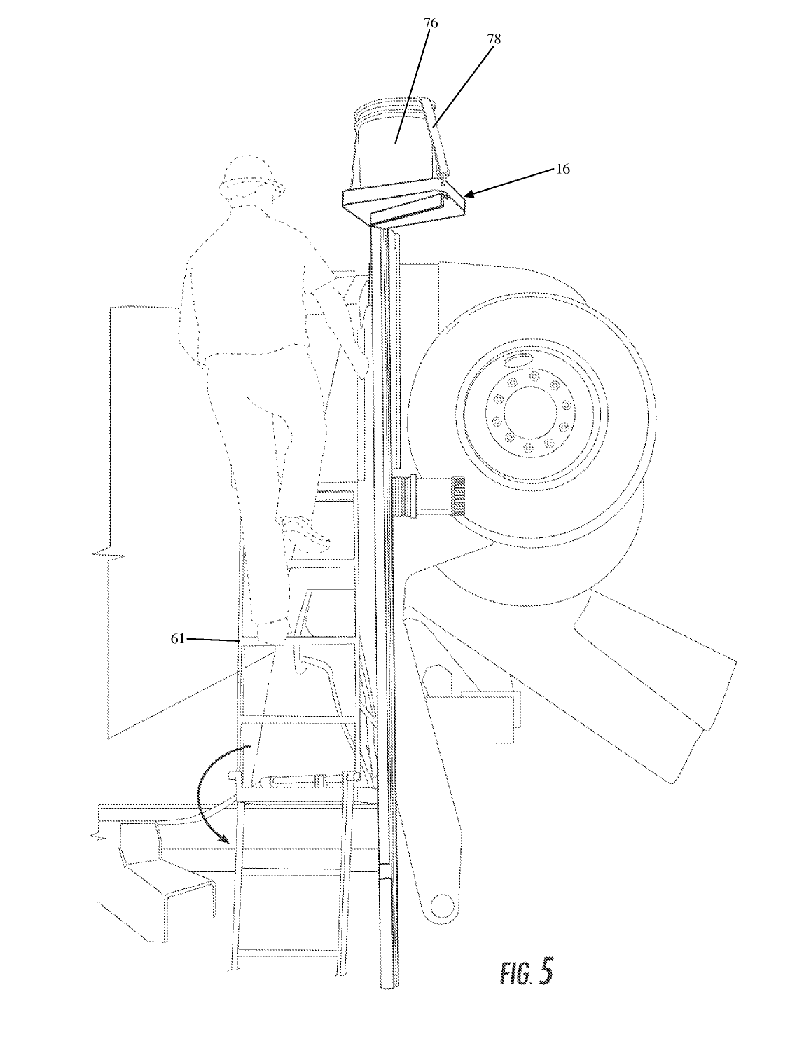

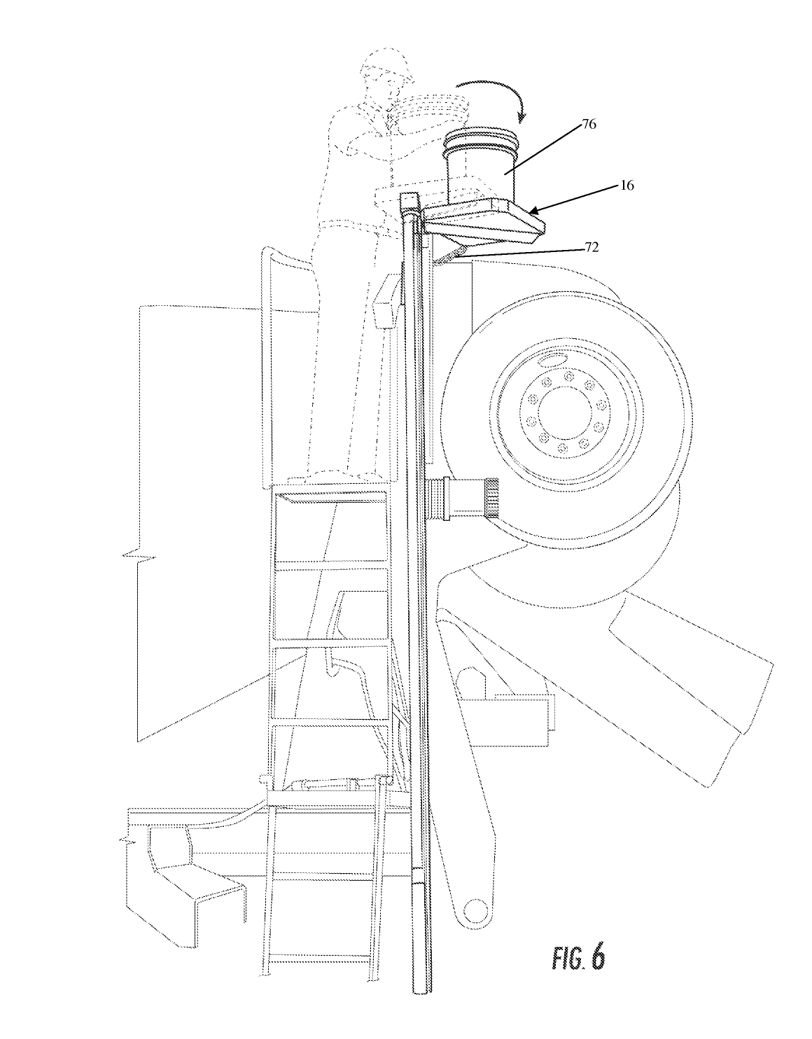

Referring to FIG. 4, a conventional, wash-down-protected control pad 52 is operatively connected to the drive winch 14 by an elongated cable for allowing an operator to command the drive winch 14 to spool or unspool the lift cable 40. A user can thereby elevate or lower the conveyor platform 16 along the length of the lift shaft 20 between an “up” position, wherein the conveyor platform 16 is adjacent the mouth of the cement truck's mixing drum as shown in FIG. 5, and a “down” position, wherein the conveyor platform 16 is adjacent the bottom of the lift shaft 20. The control pad 52 includes “UP” and “DOWN” buttons, and preferably also includes an emergency stop (“E-STOP”) button. It is contemplated that the control pad 52 can include additional buttons or switches, such as for increasing or decreasing the speed with which the drive winch 14 spools and unspools the lift cable 40. It is further contemplated that conventional limit switches, such as proximity switches, can be mounted in the lift shaft 20 adjacent the “up” and “down” positions and operatively connected to the drive winch 14 for automatically stopping the vertical movement of the conveyor platform 16 when the conveyor platform 16 reaches the “up” and “down” positions, respectively. Still further, it is contemplated that a separate, additional control pad can be installed adjacent the “up” position for allowing an operator to control the winch when adjacent the upper end of the lift shaft 20 without carrying a control pad up the ladder. Still further, it is contemplated that the operator can be provided with a wearable safety strap that is operatively connected to a conventional “dead man” switch for halting operation of the drive winch 14 should the operator accidentally fall from the ladder 61.

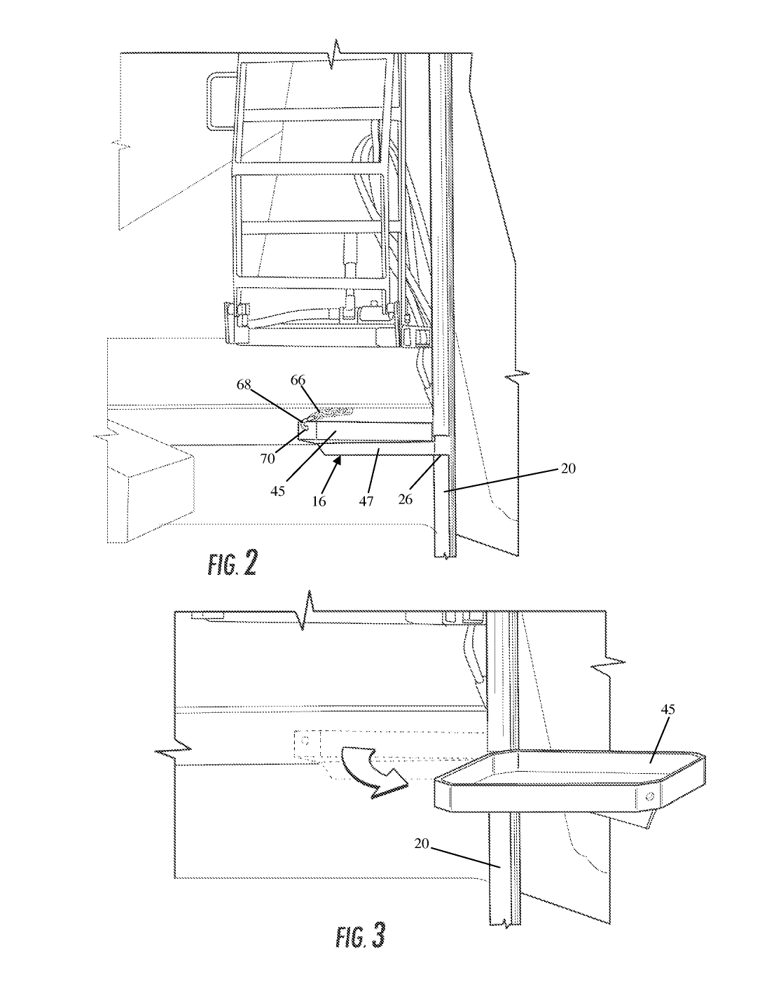

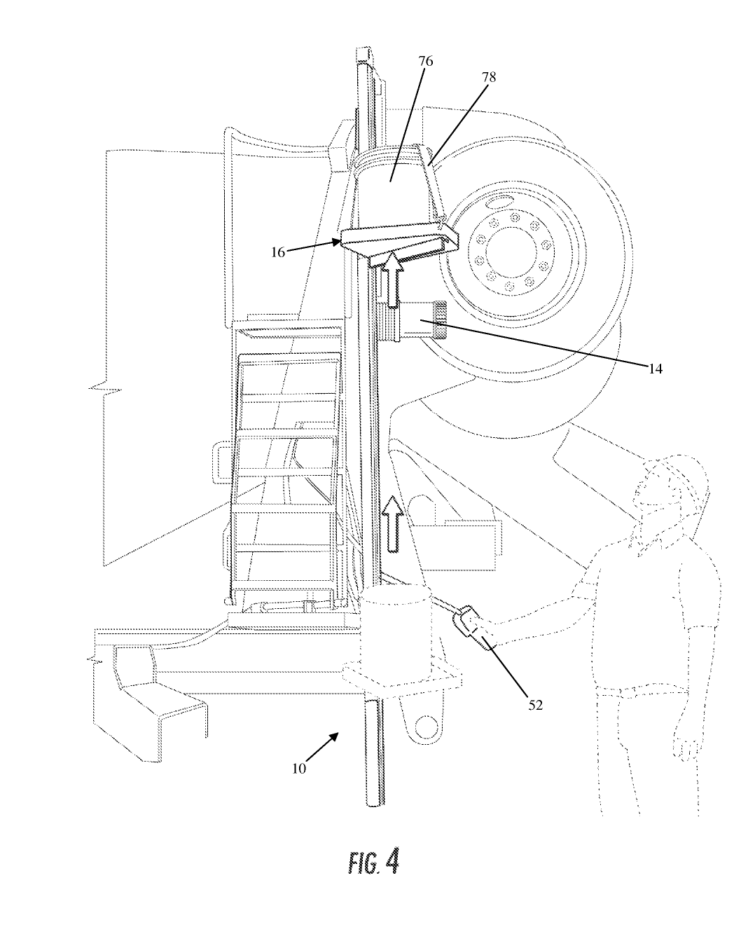

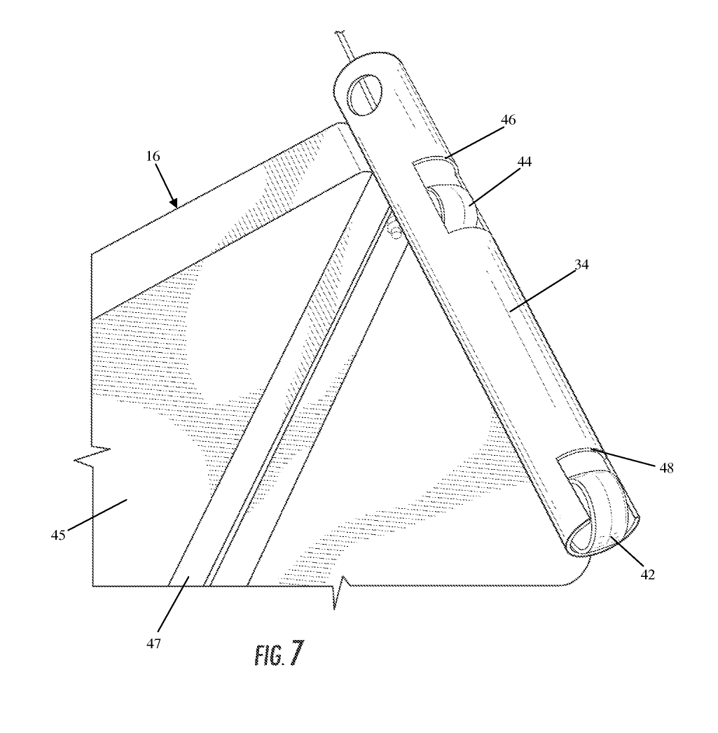

The vertical edges of the lift shaft's wall that define the guide slot 24 are relatively closely spaced to prevent significant horizontal movement of the mounting arm 47 along the majority of the lift shaft 20, thereby preventing significant axial rotation of the lift carriage 34 within the lift shaft 20. However, when the conveyor platform 16 is moved to the “down” position, the mounting arm 47 is horizontally aligned with the lower pivot notch 26 in the lift shaft 20 where the guide slot 24 is deliberately made very wide. The conveyor platform 16 and the lift carriage 34 can therefore be pivoted horizontally about the axis of the lift carriage 34 between a stowed position (shown in FIGS. 1 and 2) and an operating position (shown in FIGS. 3 and 4) with the mounting arm 47 pivoting into and out of the lower pivot notch 26 accordingly. Similarly, when the conveyor platform 16 is raised to the “up” position, the mounting arm 47 is horizontally aligned with the upper pivot notch 28 in the lift shaft 20. The conveyor platform 16 and the lift carriage 34 can therefore be pivoted horizontally about the axis of the lift carriage 34 between an operating position (shown in FIG. 5) and a dump position (shown in FIG. 6) with the mounting arm 47 pivoting into and out of the upper pivot notch 28.

In the stowed and dump positions, the conveyor platform 16 is positioned near the body of the cement truck 59 and is prevented from moving vertically by the horizontally-oriented edges of the pivot notches 26 and 28, respectively, which limit the vertical movement of the mounting arm 47. In the operating position, the mounting arm 47 is positioned in, and can move freely within, the guide slot 24, thereby allowing the conveyer platform 16 to be moved vertically along the lift shaft 20 between the “up” position and the “down” position.

Referring to FIG. 2, a length of chain 66 is preferably mounted to the body of the cement truck 59 adjacent the lower pivot notch 26. The chain 66 terminates in a hook 68 that can be removably fastened to the shelf member 45 of the conveyor platform 16, such as by threading the hook 68 through a loop 70 formed in the wall of the shelf member 45. The chain 66 is slightly longer than the distance between its point of attachment to the cement truck 59 and the loop 70 in the shelf member 45 when the conveyor platform 16 is in the stowed position. When connected to the shelf member 45, the chain 66 thus prevents the conveyor platform 16 from rotating away from the cement truck 59 toward the operating position, thereby mitigating the risk of damage or injury that could otherwise be caused by unintentional movement of the conveyor platform 16 away from the cement truck 59. Referring to FIG. 6, a similar chain 72 and hook 74 (not within view) extend from the cement truck 59 adjacent the upper pivot notch 28 for securing the conveyor platform 16 in the dump position. It is contemplated that any suitable type of cable, cord or rope can be substituted for the chains 66 and 72, and that any suitable type of clip, clasp, claw or other type of removable fastener can be substituted for the hooks 68 and 74. It is further contemplated that one or both of the pairs of chains 66 and 72 and hooks 68 and 74 can be omitted entirely.

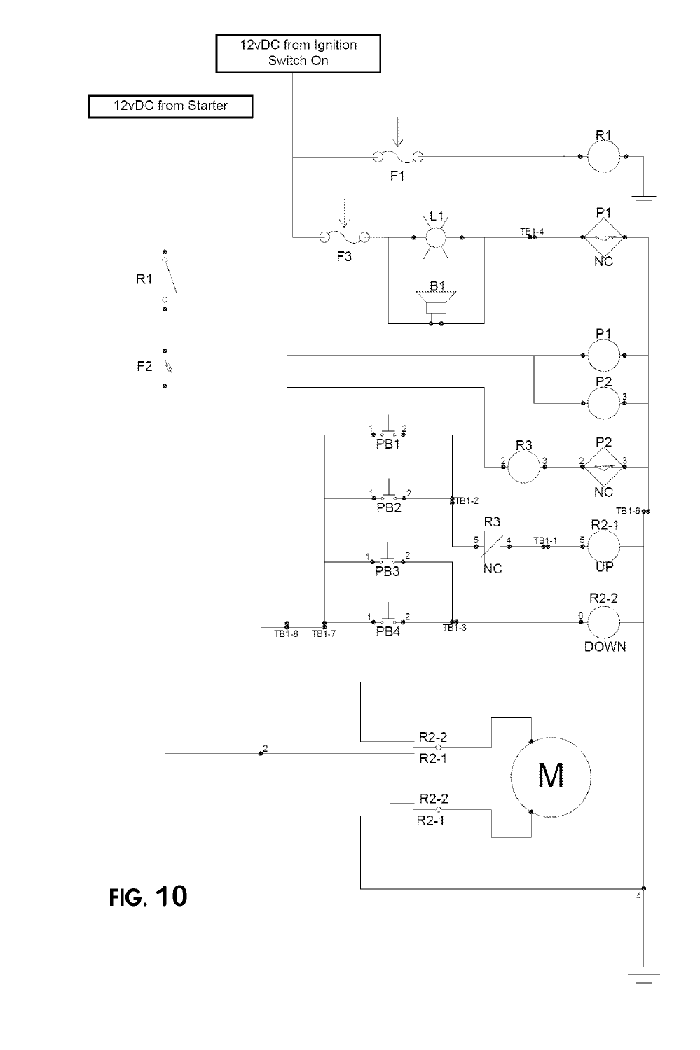

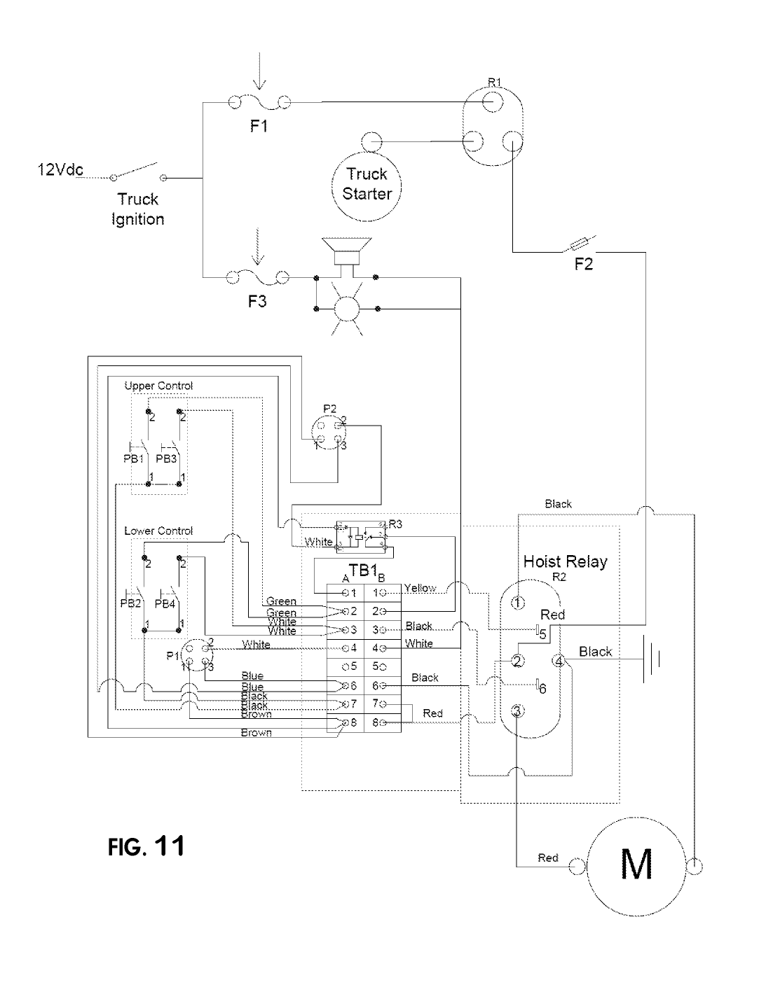

The electrical components of the preferred embodiment of the present invention are shown schematically in FIGS. 10 and 11. The diagrams of FIGS. 10 and 11 should not be considered limiting as to how the components of the invention are arranged or connected to one another, but merely as one example of their arrangement and connection.

Typical operation of the elevator 10 will now be described with reference to FIGS. 1-6. When the elevator 10 is not in use, such as when the cement truck 59 is in transit, the conveyor platform 16 will typically be secured in the stowed position with the chain 66 connected to the conveyor platform 16. When an operator wishes to use the elevator 10, the chain 66 is disconnected from the conveyor platform 16 and the conveyor platform 16 is manually rotated about the axis of the lift carriage 34 to the operating position with the mounting arm 47 in the guide slot 24, as shown in FIG. 3. The operator then places an item, such as bucket 76 of color mix or another cement additive, on the shelf member 45 of the conveyor platform 16. Of course, the shelf member 45 can also hold bags, boxes and other containers. An adjustable safety strap 78 is preferably connected to the shelf member 45, such as with hooks at either end of the strap 78, and is tightened over the bucket 76 to prevent the bucket 76 from falling off of the shelf member 45 as the bucket 76 is lifted.

Next, the operator depresses the UP button on the control pad 52 of the drive winch 14 to spool the lift cable 40, thereby hoisting the lift carriage 34, the conveyor platform 16 and the bucket 76 upwardly, along the lift shaft 20. The operator continues to elevate the conveyor platform 16 until it reaches the “up” position, with the mounting arm 47 horizontally aligned with the upper pivot notch 28 in the lift shaft 20. Next, the operator climbs to the top of the ladder 61 in a conventional manner. The operator then manually pivots the conveyor platform 16 to the dump position and connects the chain 72 to the conveyor platform 16 in the manner described above. Next, the operator removes the bucket 76 from the shelf member 45 and dumps the contents of the bucket 76 into the mouth of the mixing drum. The operator then replaces the bucket 76 on the shelf member 45, straps the bucket 76 down, disconnects the chain 72 from the conveyor platform 16, and rotates the conveyor platform 16 to the operating position. Finally, the operator climbs down the ladder 61 and depresses the DOWN button on the control pad 52 to lower the conveyor platform 16 to the “down” position. The elevator 10 can then be used again in the manner described above, or the conveyor platform 16 can be secured in the stowed position so that it is out of the way.

Referring to FIG. 8, the open bottom end of the lift shaft 20 is obstructed by a bolt 80 that passes transversely through the wall of the lift shaft 20 for preventing the lift carriage 34 from falling out of the lift shaft 20 if the lift cable 40 breaks or is lowered too far. In order to access the lift carriage 34 for any necessary maintenance, an operator can remove the bolt 80 and use the control pad 52 of the drive winch 14 to carefully lower the lift carriage 34 out of the open bottom end of the lift shaft 20. It is contemplated that any type of suitable removable stop, such as a threaded cap or plug, can be substituted for the bolt 80. It is further contemplated that an aperture with a lockable door or hatch can be formed in the wall of the lift shaft 20 as an additional or alternative means for accessing the lift carriage 34.

Although the apparatus shown and described herein is preferred, other structures are contemplated for accomplishing the same or similar purposes. For example, it is contemplated that, instead of a driven cable, a different drive linkage, such as a screw drive, can be used. In this alternative, a threaded shaft in the pipe is drivingly linked to a prime mover, such as an electric, pneumatic or hydraulic motor, at the lower end to drive the lift carriage vertically by the shaft rotating about its central axis within a threaded bore mounted to the lift carriage. Alternatively, although it is preferred for the conveyor platform to lift only the container of material to be added to the mixture of concrete and the person climbs a ladder on the truck, it is contemplated that a conveyor platform can be constructed to lift the person and the container of material. In this embodiment, the drive mechanism preferably extends lower than on the preferred embodiment so the lift platform can be accessed from ground level.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A cement truck lift elevator for assisting an operator with lifting items to the mouth of a cement truck's mixing drum, the lift elevator comprising:
a) an elongated, tubular lift housing mounted to the cement truck, the lift housing having an elongated guide slot formed therein;
b) a lift carriage mounted within, and vertically movable relative to, the lift housing;
c) a conveyor platform attached to the lift carriage by a mounting arm that extends through the guide slot;
d) a prime mover disposed adjacent one end of the lift housing; and
e) a linkage operatively connected at one end to the prime mover, the linkage extending through the lift housing and drivingly linking to the lift carriage for moving the lift carriage within the lift housing.

2. The lift elevator in accordance with claim 1, wherein the prime mover comprises a drive winch disposed adjacent one end of the lift housing and the linkage comprises a lift cable operatively connected at one end to the drive winch with the lift cable extending through the lift housing and connecting at a second end to the lift carriage.

3. The lift elevator in accordance with claim 2, further comprising at least one wheel mounted to the lift carriage for engaging an interior of the lift housing and allowing the lift carriage to travel smoothly therein.

4. The lift elevator in accordance with claim 2, wherein the lift carriage and the mounting arm are rotatable relative to the lift housing.

5. The lift elevator in accordance with claim 4, further comprising a lower pivot notch formed in the lift housing adjacent a “down” position of the conveyor platform, wherein the lower pivot notch extends perpendicularly from the guide slot for accepting the mounting arm and allowing mounting arm and the conveyor platform to be pivoted between an operating position, wherein the mounting arm is in the guide slot, and a stowed position, wherein the mounting arm is in the lower pivot notch.

6. The lift elevator in accordance with claim 4, further comprising an upper pivot notch formed in the lift housing adjacent an “up” position of the conveyor platform, wherein the upper pivot notch extends perpendicularly from the guide slot for accepting the mounting arm and allowing the mounting arm and the conveyor platform to be pivoted between an operating position, wherein the mounting arm is in the guide slot, and a dump position, wherein the mounting arm is in the upper pivot notch.

7. The lift elevator in accordance with claim 2, wherein the mounting arm is pivotably connected to the lift carriage.

8. The lift elevator in accordance with claim 7, further comprising a lower pivot notch formed in the lift housing adjacent a “down” position of the conveyor platform, wherein the lower pivot notch extends perpendicularly from the guide slot for accepting the mounting arm and allowing the mounting arm and the conveyor platform to be pivoted between an operating position, wherein the mounting arm is in the guide slot, and a stowed position, wherein the mounting arm is in the lower pivot notch.

9. The lift elevator in accordance with claim 7, further comprising an upper pivot notch formed in the lift housing adjacent an “up” position of the conveyor platform, wherein the upper pivot notch extends perpendicularly from the guide slot for accepting the mounting arm and allowing mounting arm and the conveyor platform to be pivoted between an operating position, wherein the mounting arm is in the guide slot, and a dump position, wherein the mounting arm is in the upper pivot notch.

10. The lift elevator in accordance with claim 2, further comprising at least one transmission pulley mounted within the lift housing that operatively engages and redirects the lift cable.

11. The lift elevator in accordance with claim 2, further comprising at least one control pad connected to the drive winch for allowing an operator to control the operation of the drive winch to move the conveyor platform between a “down” position, wherein the conveyor platform is adjacent a lower end of the lift housing, and an “up” position, wherein the conveyor platform is adjacent an upper end of the lift housing.

12. The lift elevator in accordance with claim 2, further comprising a fastener extending from the cement truck adjacent a “down” position of the conveyor platform for securing the conveyor platform in the stowed position.

13. The lift elevator in accordance with claim 2, further comprising a fastener extending from the cement truck adjacent an “up” position of the conveyor platform for securing the conveyor platform in the dump position.

14. The lift elevator in accordance with claim 2, further comprising a limit switch mounted adjacent an “up” position of the conveyor platform and operatively connected to the drive winch for automatically stopping the conveyor platform when it reaches the “up” position.

15. The lift elevator in accordance with claim 2, further comprising a limit switch mounted adjacent a “down” position of the conveyor platform and operatively connected to the drive winch for automatically stopping the conveyor platform when it reaches the “down” position.

16. The lift elevator in accordance with claim 2, further comprising an adjustable strap connected to the conveyor platform for securing an item to the conveyor platform.

17. A cement truck lift elevator for assisting an operator with lifting items to the mouth of a cement truck's mixing drum, the lift elevator comprising:
a) an elongated, tubular lift housing mounted to the cement truck, the lift housing having an elongated guide slot formed therein;
b) a lift carriage mounted within, and vertically movable relative to, the lift housing;
c) a conveyor platform attached to the lift carriage by a mounting arm that extends through the guide slot;
d) a drive winch disposed adjacent one end of the lift housing; and
e) a lift cable operatively connected at one lift cable end to the drive winch, the lift cable extending through the lift housing and connecting at a second lift cable end to the lift carriage;
f) at least one transmission pulley mounted within the lift housing that engages and redirects the lift cable;
g) at least one control pad connected to the drive winch for allowing an operator to control the operation of the drive winch to move the conveyor platform between a “down” position, wherein the conveyor platform is adjacent a lower end of the lift housing, and an “up” position, wherein the conveyor platform is adjacent an upper end of the lift housing;
h) a lower pivot notch formed in the lift housing adjacent the “down” position of the conveyor platform, wherein the lower pivot notch extends perpendicularly from the guide slot for accepting the mounting arm and allowing the mounting arm and the conveyor platform to be pivoted between an operating position, wherein the mounting arm is in the guide slot, and a stowed position, wherein the mounting arm is in the lower pivot notch; and
i) an upper pivot notch formed in the lift housing adjacent the “up” position of the conveyor platform, wherein the upper pivot notch extends perpendicularly from the guide slot for accepting the mounting arm and allowing the mounting arm and the conveyor platform to be pivoted between an operating position, wherein the mounting arm is in the guide slot, and a dump position, wherein the mounting arm is in the upper pivot notch.

18. A cement truck lift elevator for assisting an operator with lifting items to the mouth of a cement truck's mixing drum, the lift elevator comprising:
a) a frame mounted to the cement truck;
b) a conveyor platform mounted to, and vertically movable relative to, the frame;
c) a drive winch disposed adjacent the frame; and
d) a lift cable operatively connected at one end to the drive winch, extending along the frame and connecting at a second end to the vertically movable conveyor platform.

19. A method for lifting a container to the mouth of a cement truck's mixing drum, the method comprising:
a) disposing an elongated, tubular lift housing to the cement truck, the lift housing having an elongated guide slot formed therein;
b) mounting a lift carriage within, and vertically movable relative to, the lift housing;
c) attaching a conveyor platform to the lift carriage by a mounting arm that extends through the guide slot;
d) disposing a drive winch adjacent one end of the lift housing;
e) operatively connecting a first end of the lift cable to the drive winch;
f) extending the lift cable through the lift housing and connecting a second lift cable end to the lift carriage;
g) mounting at least one transmission pulley in the lift housing, wherein said at least one pulley engages and redirects the lift cable;
h) rotating the conveyor platform from a stowed position to an operating position;
i) placing a container on the conveyor platform;
j) connecting at least one control pad to the drive winch and controlling the drive winch to move the conveyor platform from a “down” position, wherein the conveyor platform is adjacent a lower end of the lift housing, to an “up” position, wherein the conveyor platform is adjacent an upper end of the lift housing and a mouth of the mixing drum;
k) rotating the conveyor platform to a dump position; and
l) removing the container from the conveyor platform and dumping the contents of the container into the mouth of the mixing drum.

20. The method in accordance with claim 19, further comprising securing the conveyor platform in the dump position with a fastener.

21. The method in accordance with claim 19, further comprising:
a) rotating the conveyor platform from the dump position to the operating position;
b) placing the container on the conveyor platform;
c) operating the drive winch to move the conveyor platform to the “down” position; and
d) rotating the conveyor platform to the stowed position.

22. The method in accordance with claim 21, further comprising securing the conveyor platform in the stowed position with a fastener.
